(19) United States
(12) Patent Application Publication
(10) Pub. No.: US 2018/0035246 A1
(43) Pub. Date: Feb. 1, 2018

(54) TRANSMITTING AUDIO OVER A WIRELESS LINK

(71) Applicant: Bose Corporation, Framingham, MA (US)

(72) Inventor: Marko Orescanin, Framingham, MA (US)

(21) Appl. No.: 15/225,432

(22) Filed: Aug. 1, 2016

(51) Int. Cl. H04W 4/00; G10L 19/16; H04R 1/10; H04L 29/06

(52) U.S. Cl. CPC H04W 4/008; H04L 65/607; H04L 65/4069; G10L 19/167; H04R 1/1016; H04R 2420/07

(57) ABSTRACT

The technology described in this document can be embodied in a computer-implemented method that includes receiving, at a first acoustic device, a first data stream representing audio signals encoded using a first encoding scheme, and processing, using one or more processing devices, the first data stream to generate a second data stream representing a portion of the audio signals to be decoded at a second acoustic device. The method also includes transmitting the second data stream over a near-field magnetic induction (NFMI) link to the second acoustic device.

### TECHNICAL FIELD

This disclosure generally relates to acoustic devices that employ audio codecs for encoding and decoding audio signals.

### BACKGROUND

Acoustic devices such as wireless earphones or headphones can include audio codecs for encoding and decoding audio signals. In some cases, an audio codec may act as a noise source by introducing noise in the signal processed by the codec.

### SUMMARY

In one aspect, this document describes a computer-implemented method that includes receiving, at a first acoustic device, a first data stream representing audio signals encoded using a first encoding scheme, and processing, using one or more processing devices, the first data stream to generate a second data stream representing a portion of the audio signals to be decoded at a second acoustic device. The method also includes transmitting the second data stream over a wireless link to the second acoustic device.

In another aspect, this document features an acoustic device that includes a codec and a near-field magnetic induction (NFMI) module. The codec includes one or more processing device, and is configured to receive a first data stream representing audio signals encoded using a first encoding scheme, and process the first data stream to generate a second data stream representing a portion of the audio signals to be decoded at a second acoustic device. The NFMI module is configured to transmit the second data stream over an NFMI link to the second acoustic device.

In another aspect, this document features a machine-readable storage device having encoded thereon computer readable instructions for causing one or more processors to perform various operations. The operations include receiving a first data stream representing audio signals encoded using a first encoding scheme, and processing the first data stream to generate a second data stream representing a portion of the audio signals to be decoded at a second acoustic device. The operations also include providing the second data stream for transmission over a wireless link to the second acoustic device.

Implementations of any of the above aspects may include one or more of the following features. The wireless link can include an NFMI link. The first data stream can include data representing audio signals for two or more audio channels. Processing the first data stream can include extracting a portion of the first data stream that corresponds to audio signals to be decoded at an acoustic device different from the first acoustic device, and generating the second data stream using the extracted portion. Processing the first data stream can include decoding the first data stream to generate decoded audio data, and encoding a portion of the decoded audio data in accordance with a second encoding scheme that is different from the first encoding scheme. The first encoding scheme can include a first sub-band coding (SBC) scheme. The second encoding scheme can include a second SBC scheme, wherein a number of bits used for representing a sample in the first SBC scheme is different from a number of bits used for representing a sample in the second SBC scheme. The number of bits for the second SBC scheme is selected based on a bit-rate supported by the NFMI link. The second encoding scheme can include a scheme associated with an audio codec. The audio codec can include an APTx codec, an Adaptive Differential Pulse-Code Modulation (ADPCM) codec, or an Advanced Audio Coding (AAC) codec. The first data stream can be generated by a media device in accordance with a Bluetooth® profile. The NFMI link may operate in a data transfer mode. The second data stream can be generated at a codec chip disposed in the first acoustic device. The second data stream can be transmitted by an NFMI chip that is separate from the codec chip. The first and second acoustic devices can be acoustic earphones. The NFMI link can be established through at least a portion of a human head. The second data stream can represent compressed audio that is decodable at the second acoustic device.

Various implementations described herein may provide one or more of the following advantages.

In some cases, transmitting an audio stream from one acoustic device to another (e.g., from one acoustic earbud to another) over an NFMI link is delimited by the capacity of the link. In such cases, processing a portion of the audio stream at one device prior to transmission to the other (e.g., by removing a portion of the stream, or transcoding a portion of the stream in accordance with the capacity of the link) may allow for transmission of high quality audio signals without substantial degradation.

Two or more of the features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### DESCRIPTION OF THE DRAWINGS

FIG. 1 depicts a schematic diagram illustrating signal paths in an example system that includes a set of wireless acoustic earbuds receiving audio from a source device.

FIG. 2 is a block diagram of the system depicted in FIG. 1.

FIG. 3 is a flowchart of an example process of transmitting a data stream from one acoustic device to another over an NFMI link.

### DETAILED DESCRIPTION

Wireless acoustic earbuds that are connected to one another, as well as to a source device (e.g., a phone, tablet, or other media player), over respective wireless channels have become popular as personal audio devices for various reasons such as aesthetic appeal and ease of use during various activities. The popularity of such acoustic systems is in part attributable to the lack of wires connecting the various components of the system. The lack of wired connections however creates other challenges, such as maintaining quality of the audio signals transmitted between the components. For example, transmitting audio signals from one acoustic earbud to another through a low energy wireless channel established through the head of the user can be particularly challenging. Wireless technologies such as Bluetooth® Low Energy (BLE) are used for these purposes, but the resulting audio quality can sometimes be less than acceptable. Near-Field Magnetic Induction (NFMI) based technology is increasingly being adopted to transmit audio between two acoustic earbuds. However, the data transfer rate of NFMI links can sometimes be insufficient for transmitting high quality audio signals, thereby requiring additional processing by audio codecs such as ITU G.722. Such codecs can compress the bit rate of audio signals transmitted over NFMI links, but sometimes at the cost of introducing codec-generated noise and/or adversely affecting the dynamic range of the audio signals.

This document describes various technologies for improving the quality of audio signals transmitted over a wireless channel such as an NFMI link. The quality of the audio signals can be improved, for example, by reducing the codec generated noise, and/or by reducing adverse effects of bit rate compression on dynamic ranges of the signals. In some implementations, a data stream received at one acoustic device (e.g., an acoustic earbud) can be processed, prior to transmitting to another acoustic device over an NFMI link, to generate another data stream that is supported by the NFMI link. For example, compressed audio received at one acoustic earbud can be transcoded in accordance with an encoding scheme supported by the NFMI link such that high quality audio can be rendered by decompressing the audio at the receiving earbud. In another example, a high bit rate data stream (e.g., one representing two-channel audio) can be processed at one earbud to generate a lower bit rate data stream (e.g., by removing data corresponding to one channel), which may be supported by the NFMI link.

The two different types of compression described should not confused with one another. The first type, which may also be referred to as audio compression, is a data compression technique used for generating compressed audio. Audio compression involves reducing the amount of data corresponding to audio waveforms to different degrees (e.g., depending on types of audio compression processes, and/or whether the audio compression is lossy or lossless) for transmission with or without some loss of quality. The data reduction can be performed, for example, by a codec by leveraging information redundancy in the audio data, using methods such as coding, pattern recognition, and linear prediction to reduce the amount of information used to represent the uncompressed audio data. The second type of compression is an audio level compression, in which the difference between a loud portion and a quiet portion of an audio waveform is reduced, for example, by compressing or reducing the number of bits used for representing the audio waveform. The range of audio levels that may be represented using a given number of bits used in a system can be referred to as the dynamic range of the system. In some implementations, a single codec may perform both types of compressions described above.

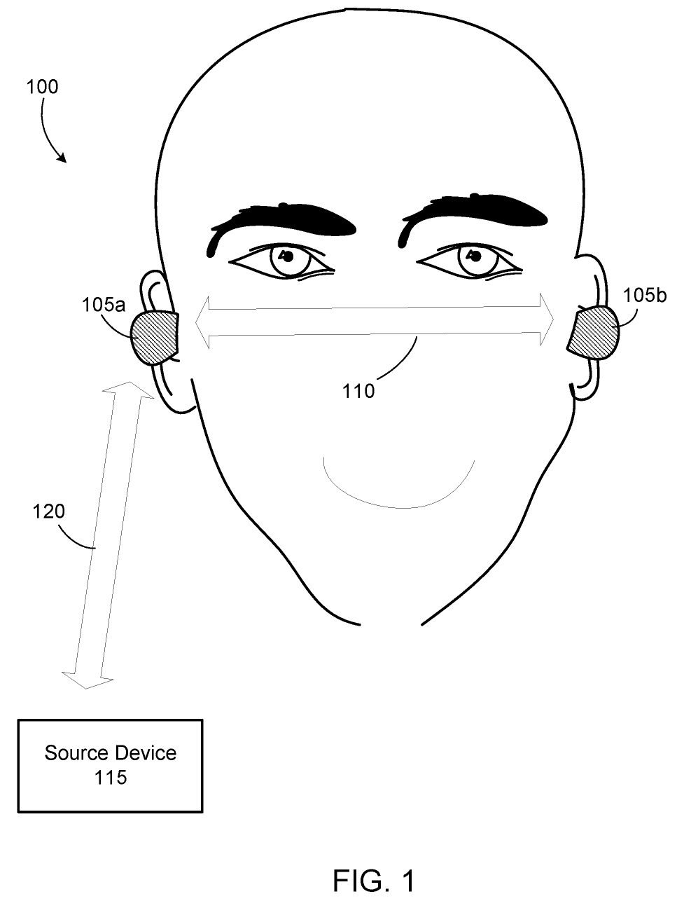

A schematic example of system 100 including two wireless acoustic earbuds is shown in FIG. 1. The system 100 includes a set of two acoustic earbuds (105a, 105b, 105 in general) that are connected to one another over a wireless link 110 such as an NFMI link. At least one of the acoustic earbuds is connected to a source device 115 that generates audio signals to be output by the earbuds 105. The connection between an earbud 105 and the source device 115 can be over a wireless channel 120 such as a Bluetooth® or Wi-Fi link. Because the wireless channel 120 is established over the environment, a latency associated with the channel 120 can depend on various factors such as a physical length of the channel or one or more environmental parameters that affect data transmission over the channel. Accordingly, transmitting audio signals separately to the two earbuds 105 may result in a latency mismatch. In some implementations, the latency mismatch can be addressed by transmitting audio signals to one of the earbuds (105a in the example of FIG. 1), which then transmits at least a portion of the audio signals to the second earbud (105b in the example of FIG. 1). This situation is depicted in the example of FIG. 1, where the source device 115 transmits audio signals over the wireless channel 120 to the earbud 105a, which then transmits a portion of the received signal to the earbud 105b over the wireless link 110.

The example of FIG. 1 shows the two earbuds 105a and 105b as discrete in-ear devices. However, the terms earbud or acoustic earbud, as used in this document, includes various types of other personal acoustic devices such as in-ear, around-ear or over-the-ear headsets, earphones, and hearing aids. The earbuds 105 may be physically tethered to each other, for example, by a cord, an over-the-head bridge or headband, or a behind-the-head retaining structure.

The earbud that receives the signal from the source device 115 can be referred to as a master, while the other earbud can be referred to as a slave. In some implementations, one of the earbuds can always function as the master while the other earbud always functions as the slave. In other implementations, the master earbud can be selected based on one or more criteria such as signal strength. For example, if a user places the source device (e.g., a smartphone) 115 in his left pocket, the left earbud may receive a stronger signal than the right earbud, and therefore be selected as the master. If the user puts the source device 115 in the right pocket, or another location where the right earbud receives a stronger signal, the roles of the master and slave may be reversed.

The source device 115 can include any device capable of generating audio signals and transmitting them to the earbuds 105. For example, the source device 115 can be a mobile device such as a smartphone, a tablet computer, an e-reader, or a portable media player. The source device 115 can also be a portable or non-portable media playing device such as a TV, a disk-player, a gaming device, a receiver, a media streaming device, or a set-top box. In some implementations, the source device 115 can be an intermediate device (e.g., a remote controller) that interfaces between a media player and the earbuds 105. In some implementations, the source device 115 can be a hearing assistance device.

In some implementations, the source device 115 includes a transceiver that can establish the wireless channel 120. In some implementations, the wireless channel 120 is established in accordance with a Bluetooth® Basic Rate/Enhanced Data Rate (BR/EDR) or Bluetooth® Low Energy (BLE) connections. For brevity, Bluetooth® Basic Rate/Enhanced Data Rate (BR/EDR) is interchangeably referred to herein as Bluetooth®. In some implementations, the wireless channel 120 is established in accordance with another communication protocol such as Near Field Communications (NFC), IEEE 802.11, or other local area network (LAN) or personal area network (PAN) protocols. In some implementations, the wireless channel 120 may support full bandwidth audio such as 48 KHz music.

The wireless link 110 is a link established between two acoustic devices such as the two earbuds 105. While this document uses an NFMI link as the primary example of the wireless link 110, other types of links are also within the scope of this disclosure. For example, some of the technologies described herein may be used when the wireless link 110 is established in accordance with BLE, Wi-Fi, or another personal area network (PAN) protocol such as body area network (BAN), ZigBee, or INSTEON. In some implementations, such as for wireless earbuds, at least a portion of the wireless link 110 is established through a human head. In some implementations, the data transfer capacity of the wireless link 110 can be less than that of the wireless channel 120, thereby requiring additional processing at the master device. The additional processing can include audio compression that may be performed, for example, by an audio codec, and the transmission over the wireless link 110 can be performed by a transceiver module such as an NFMI chip. The additional processing can also include audio level compression, including, for example, adjusting a dynamic range of the transmitted audio signals such that the signals can be transmitted using a lower number of bits.

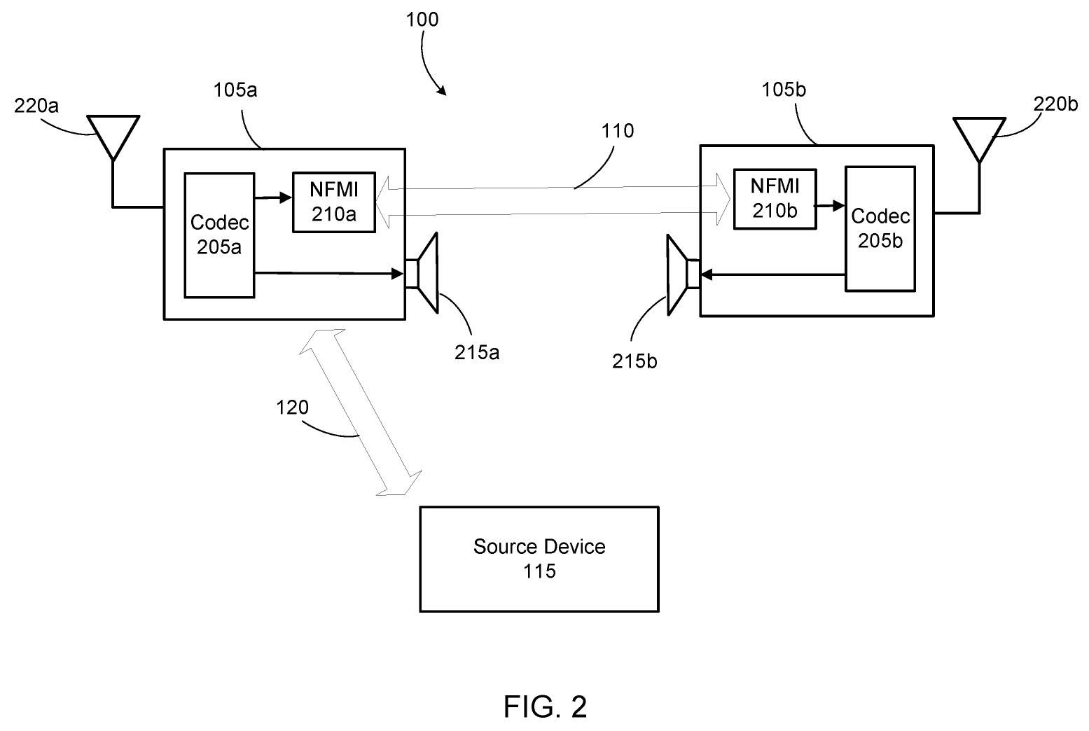

FIG. 2 is a block diagram of the system 100, the block diagram illustrating codecs 205a and 205b (205, in general) and NFMI modules 210a and 210b (210, in general) in the earbuds 105a and 105b, respectively. The earbuds 105a and 105b also include acoustic transducers 215a and 215b, respectively, for generating audio output, and one or more receivers 220a and 220b, respectively, for receiving signals from the source device 115. In some implementations, where the wireless channel 120 is a Bluetooth® connection, the audio signals can be transmitted from the source device 115 using, for example, a Bluetooth® profile such as Advanced Audio Distribution Profile (A2DP). An A2DP profile can allow transfer of an audio stream in up to 2 channel stereo, from the source device 115 to the master earbud 105a. In some implementations, the A2DP stream can be encoded using codecs such as a sub-band coding (SBC) codec or Advanced Audio Coding (AAC) codec. In some implementations, other Bluetooth® profiles such as Generic Audio/Video Distribution Profile (GAVDP) can also be used in place of A2DP.

Audio signals received at the master earbud (105a, in this example) from the source device 115 over the wireless channel 120 can be processed by the codec 205a and output through a corresponding acoustic transducer 215a. The codec 205a can also process at least a portion of the audio signal and transmit the processed portion through the NFMI module 210a to the slave earbud (105b, in this example) over the wireless link 110. At the slave side, the corresponding NFMI module 210b receives the signal and passes it on to the codec 205b. The slave codec 205b then processes the received signal and generates audio output through the corresponding acoustic transducer 215b.

The NFMI module 210 can be implemented using an NFMI radio chip such as N×H 2280 developed by NXP Semiconductors. The NFMI module can include, for example, a transceiver coil for magnetic transmission and reception of data, and associated circuitry that enables the transmission and reception. In some implementations, the NFMI module 210 can include one or more processing devices such as an ARM processor. In some implementations, the one or more processing devices may also be shared with the codec 205. For example, the NFMI module can include a DSP that executes at least a portion of the operations of the codec 205.

The codec 205 can be of various types. In some implementations, the codec 205 can be an Adaptive Differential Pulse-Code Modulation (ADPCM) codec such as the ITU G.722 codec. The ITU G.722 is a wideband audio codec that can be configured to operate at 48, 56 and 64 kbit/s. Other examples of codecs that may be used include SBC codec, FastStream, and APTx. In some implementations, the codecs can be implemented on a processing device such as a digital signal processing (DSP) chip or a System-on-Chip (SoC). An example of a SoC includes CSR 8670 developed by CSR plc., a subsidiary of Qualcomm Inc. If a DSP or SoC is included in the earbuds 105, additional processing of the audio stream received over the wireless channel 120 can be performed before transmitting a portion of the received stream through the NFMI module.

In some implementations, a portion of the audio stream received over the wireless channel 120 can be removed from the stream by the DSP or SoC to reduce the bit rate of the stream to be transmitted over the wireless link 110. For example, if an A2DP stream is received over the wireless channel 120, the DSP or SoC can be configured to extract one of the two audio channels in the A2DP stream, and pass on the stream for the other channel over the wireless link 110. This can be done, for example, without decoding the A2DP stream, and thereby transmitting compressed audio over the wireless link 110 to be decoded at the slave earbud. In some implementations, this may result in high quality audio being rendered or output by the slave earbud while satisfying the bandwidth constraints of the wireless link 110.

In some implementations, the audio signals (e.g., an A2DP stream) received over the wireless channel 120 can be decoded by the DSP or SoC at the master device, and then re-encoded in accordance with an encoding scheme that is compatible with the wireless link 110. This process may be referred to as transcoding, and allows for compressed audio to be transmitted over the wireless link 110 to be decoded at the slave earbud. Transcoding in accordance with an encoding scheme compatible with the wireless link 110 can allow for satisfying bandwidth requirements of the wireless link 110 while still transmitting compressed audio to preserve audio quality. In some cases, compressed audio may be preferred over uncompressed audio to allow for higher quality audio to be transmitted over a bandwidth-constrained channel such as the wireless link 110. In addition, in some cases (e.g., where the wireless link 110 is an NFMI link), compressed audio can be transmitted in a data transfer mode in which the throughput is higher than that for an audio transfer mode used for uncompressed audio signals. For example, compressed audio may be transferred, for example, at a throughput of 200 or 300 kbps, which is higher than the throughput (e.g., 100 kbps) that may be achieved for uncompressed audio.

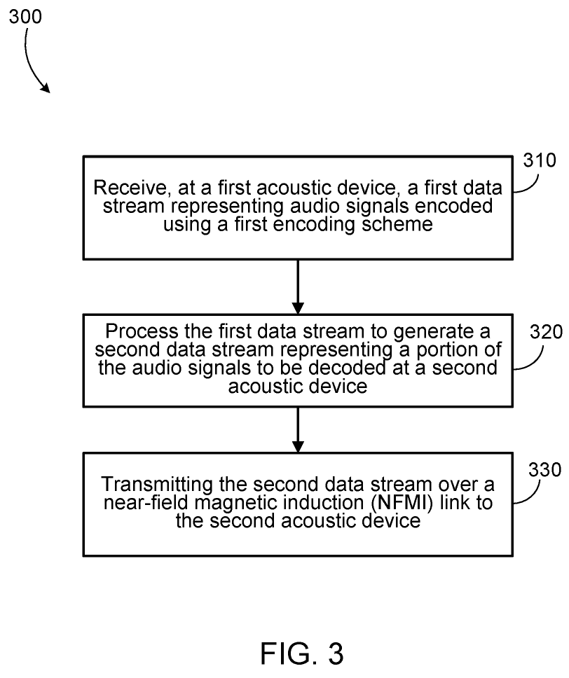

FIG. 3 is a flowchart of an example process 300 of transmitting a data stream from one acoustic device to another over an NFMI link. The acoustic devices can be acoustic earbuds such as the earbuds 105 described with reference to FIG. 1. In some implementations, at least a portion of the process can be executed by a DSP or SoC such as ones described above with reference to FIG. 2. A portion of the process 300 can also be executed by the NFMI module 210 described above. Operations of the process include receiving, at a first acoustic device, a first data stream representing audio signals encoded using a first encoding scheme (310). In some implementations, the first data stream can include data representing audio signals for two or more audio channels. For example, the first data stream can be an A2DP data stream that includes data corresponding to audio signals for two channels (e.g., left speaker and right speaker) of an audio system. The data stream can also include data for more than two channels, e.g., five or seven channels for a 5.1 or 7.1 home theater systems, respectively. The first data stream can be generated by a source device such as the source device 115 described with reference to FIG. 1. The source device can include a media playing device capable of generating the first stream in accordance with a Bluetooth® profile such as the A2DP profile.

Operations of the process 300 also include processing the first data stream to generate a second data stream representing a portion of the audio signals to be decoded at a second acoustic device (320). For example, the second data stream can represent compressed audio that is decodable by a codec at the second acoustic device. This can be done, for example at a codec such as the codec 205 described above. In some implementations, processing the first data stream can include extracting a portion of the first data stream, and generating the second data stream using the extracted portion. For example, if the first data stream is an A2DP stream that includes two channels for a left and right speaker, respectively, the first data stream can be processed by the master earbud (e.g., a left earbud) to extract the channel for the slave right earbud, and second stream can be generated using the extracted portion. Data in the channel for the left speaker can be processed by the codec at the master earbud and output via a corresponding acoustic transducer. In some implementations, the extracted portion may be rendered or output by the acoustic transducer at the master, while the residual portion is used to generate the second stream.

In some implementations, generating the second stream includes a transcoding process. For example, the first data stream can be decoded to generate decoded audio data, and a portion of the decoded audio data can be re-encoded in accordance with a second encoding scheme that is different from the first encoding scheme. The first and second encoding schemes can be of different types. In some implementations, the first encoding scheme includes a first SBC scheme and the second encoding scheme comprises a second SBC scheme, wherein the two SBC encoding schemes vary in the number of bits per sample. For example, the number of bits used for representing a sample in the first SBC scheme can be different from a number of bits used for representing a sample in the second SBC scheme. The number of bits for the second SBC scheme can be selected to be less than that for the first SBC scheme to make the second encoding scheme compatible with a bandwidth-constrained channel such as an NFMI link. For example, the number of bits for the second SBC can be selected in accordance with a bit rate supported by the NFMI link.

Operations of the process 300 also include transmitting the second data stream over an NFMI (or other wireless) link to the second acoustic device (330). In implementations where the first and second acoustic devices are earbuds, the link may be established through at least a portion of the human head. In some implementations, the second data stream can be transmitted by a module or chip (e.g., an NFMI chip) that is separate from the codec chip that generates the second data stream.

Referring again to FIG. 2, in some implementations, the codec 205 is selected in accordance with one or more requirements related to power and latency. In such cases, ADPCM codecs such as the ITU G.722 can be desirable due to their low power and low latency performance in generating low bit rate data streams. A G.722 based codec may be adapted to transmit full bandwidth audio (e.g., 48 KHz music) over a wireless link (e.g., an NFMI link), by scaling the operating sampling frequency by an appropriate factor. For example, the G.722 codec can be adapted to operate at 48 KHz instead of the standard 16 KHz by scaling the internal operating sample rate by a factor of 3. This can be used, for example, to transmit high quality audio over an NFMI wireless link in which the available physical bandwidth may be inadequate to support uncompressed audio transmission. This results in a compression of the bit rate to make the transmissions compatible with the NFMI link.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media or storage device, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Other embodiments and applications not specifically described herein are also within the scope of the following claims. For example, the level of control on the instability mitigation can be tailored based on various parameters such as probability of detection, and target false positive and/or false negative rates. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

1. A computer-implemented method comprising:
receiving, at a first acoustic device, a first data stream representing audio signals encoded using a first encoding scheme, the first acoustic device being selected over a second acoustic device to receive the first data stream, the selection of the first acoustic device being made based on a comparison of received signal strengths from the first acoustic device and the second acoustic device;
processing, using one or more processing devices, the first data stream to generate a second data stream representing a portion of the audio signals to be decoded at a second acoustic device; and
transmitting the second data stream over a wireless link to the second acoustic device.

2. The method of claim 1, wherein the wireless link comprises a near-field magnetic induction (NFMI) link.

3. The method of claim 1, wherein the first data stream comprises data representing audio signals for two or more audio channels.

4. The method of claim 3, wherein processing the first data stream comprises:
extracting the portion of the first data stream that corresponds to audio signals to be decoded at an acoustic device different from the first acoustic device; and
generating the second data stream using the extracted portion.

5. The method of claim 1, wherein processing the first data stream comprises:
decoding the first data stream to generate decoded audio data; and
encoding a portion of the decoded audio data in accordance with a second encoding scheme that is different from the first encoding scheme.

6. The method of claim 5, wherein the first encoding scheme comprises a first sub-band coding (SBC) scheme and the second encoding scheme comprises a second SBC scheme, and wherein a number of bits used for representing a sample in the first SBC scheme is different from a number of bits used for representing a sample in the second SBC scheme.

7. The method of claim 6, wherein the number of bits for the second SBC scheme is selected based on a bit-rate supported by the wireless link.

8. The method of claim 5, wherein the first encoding scheme comprises a sub-band coding (SBC) scheme and the second encoding scheme comprises a scheme associated with an audio codec.

9. The method of claim 8, wherein the audio codec is selected from a group consisting of an APTx codec, an Adaptive Differential Pulse-Code Modulation (ADPCM) codec, and an Advanced Audio Coding (AAC) codec.

10. The method of claim 1, wherein the first data stream is generated by a media device in accordance with a Bluetooth® profile.

11. The method of claim 2, wherein the NFMI link operates in a data transfer mode.

12. The method of claim 1, wherein the second data stream is generated at a codec chip disposed in the first acoustic device.

13. The method of claim 12, wherein the second data stream is transmitted by an NFMI chip that is separate from the codec chip.

14. The method of claim 1, wherein the first and second acoustic devices are acoustic earphones.

15. The method of claim 1, wherein the wireless link is established through at least a portion of a human head.

16. The method of claim 1, wherein the second data stream represents compressed audio that is decodable at the second acoustic device.

17. An acoustic device comprising:
a codec comprising one or more processing devices, the codec configured to:
receive a first data stream representing audio signals encoded using a first encoding scheme, wherein the first data stream is received at the codec responsive to the acoustic device being selected over a different, second acoustic device, the selection of the acoustic device being based on a comparison of received signal strengths from the acoustic device and the second acoustic device, and
process the first data stream to generate a second data stream representing a portion of the audio signals to be decoded at the second acoustic device; and
a near-field magnetic induction (NFMI) module configured to transmit the second data stream over an NFMI link to the second acoustic device.

18. The acoustic device of claim 17, wherein the first data stream comprises data representing audio signals for two or more audio channels.

19. The acoustic device of claim 18, wherein processing the first data stream comprises:
extracting the portion of the first data stream that corresponds to audio signals to be decoded at a different acoustic device; and
generating the second data stream using the extracted portion.

20. The acoustic device of claim 17, wherein processing the first data stream comprises:
decoding the first data stream to generate decoded audio data; and
encoding a portion of the decoded audio data in accordance with a second encoding scheme that is different from the first encoding scheme.

21. The acoustic device of claim 20, wherein the first encoding scheme comprises a first sub-band coding (SBC) scheme and the second encoding scheme comprises a second SBC scheme, and wherein a number of bits used for representing a sample in the first SBC scheme is different from a number of bits used for representing a sample in the second SBC scheme.

22. The acoustic device of claim 21, wherein the number of bits for the second SBC scheme is selected based on a bit-rate supported by the NFMI link.

23. The acoustic device of claim 20, wherein the first encoding scheme comprises a sub-band coding (SBC) scheme and the second encoding scheme comprises a scheme associated with an audio codec selected from a group consisting of an APTx codec, an Adaptive Differential Pulse-Code Modulation (ADPCM) codec, and an Advanced Audio Coding (AAC) codec.

24. The acoustic device of claim 17, wherein the first and second acoustic devices are acoustic earphones.

25. The acoustic device of claim 17, wherein the second data stream represents compressed audio that is decodable at the second acoustic device.

26. A machine-readable storage device having encoded thereon computer readable instructions for causing one or more processors to perform operations comprising:
receiving a first data stream representing audio signals encoded using a first encoding scheme, wherein the first data stream is received at a first acoustic device selected over a second acoustic device, the selection of the first acoustic device being based on a comparison of received signal strengths from the first acoustic device and the second acoustic device;
processing the first data stream to generate a second data stream representing a portion of the audio signals to be decoded at the second acoustic device; and
providing the second data stream for transmission over a wireless link to the second acoustic device.
